(19) United States
(12) Patent Application Publication
(10) Pub. No.: US 2005/0241573 A1
(43) Pub. Date: Nov. 3, 2005

(54) Gravure coating apparatus, and optical film

(76) Inventors: Tomonari Ogawa, Fujinomiya-shi (JP); Shuichi Endo, Fujinomiya-shi (JP); Atsushi Kodo, Fujinomiya-shi (JP)

Correspondence Address: YOUNG & THOMPSON, 745 SOUTH 23RD STREET, 2ND FLOOR, ARLINGTON, VA, 22202, US

(21) Appl. No.: 11/090,850

(22) Filed: Mar. 25, 2005

(30) Foreign Application Priority Data
Mar. 26, 2004 (JP) 2004-093658

(51) Int. Cl. B05C 1/08; B05C 1/00

(52) U.S. Cl. 118/258; 118/204; 118/211

(57) ABSTRACT

According to the present invention, since the gravure roller with no load has a radial run out of 15 μm or less in all places of a pattern part in which cells are formed (the gravure plate cylinder) on the surface of the gravure roller, liquid accumulations (beads) are hardly affected by the radial run out of the roller surface, thereby making it possible to prevent coating nonuniformity.

### BACKGROUND OF THE INVENTION

1. Field of the Invention

The present invention relates to a gravure coating apparatus and optical films, in particular, to a gravure coating apparatus suitably applied to the production of optical films such as optical compensation films, antireflection films, antiglare films, optical films useful for improving the nonuniformity of liquid crystal layers, and to optical films produced by using the gravure coating apparatus.

2. Related Art

In recent years, optical films are now in increasing demand. These optical films are typified by films with various functions such as optical compensation films used as phase difference plates for liquid crystal cells, antireflection films and antiglare films.

A representative example of the method for producing these optical films includes a method in which coating films of various compositions are formed on a surface of a belt-like flexible substrate (hereinafter referred to as a “web”) using various coating apparatuses.

Theses coating apparatuses are typified by a wire bar coater, a gravure coater or a roll coater, and the gravure coater (gravure coating apparatus) is often preferably used.

In order to achieve a state of stable coating where any coating nonuniformity appears using such a gravure coating apparatus, it is effective to decrease the radial run out in a pattern part in which cells are formed (a gravure plate cylinder) on the surface of a gravure roller.

As a device for the above-described purpose, for example, Japanese Patent Application Laid-open No. 2003-56551 proposes adjusting assemblage attitude of a bearing while measuring the distortion at the bearing part of a roller, thereby improving rotational accuracy of the roller.

### SUMMARY OF THE INVENTION

However, even the above-described gravure coating apparatus cannot achieve sufficient performance under present circumstances. Specifically, a coating solution has conventionally been supplied to depressions (cells) formed on the gravure roller surface from a receiving pan containing the coating liquid to be coated, and an excess coating liquid adhered to the outside of the depressions has been scraped off with a blade or the like, thereby transferring the quantity corresponding to the volume of the depressions to a web.

However, the need for thin-layer coating is increasing in recent years. In this case, although a thin-layer can be formed by reducing the volume of the depressions, very small liquid accumulations are formed because the liquid volume of each liquid accumulation (bead) that is sufficient for transferring is small. Consequently, the radial run out of the gravure roller surface affects the liquid accumulations, often causing linear nonuniformity in a width direction of a web, which is a serious problem.

Furthermore, since the coating layer is a thin layer, it is impossible to take sufficient time to level the liquid in order to eliminate the difference of the coating volume that causes the nonuniformity, leading to an easy manifestation of the nonuniformity.

On the other hand, as described in the above-described Japanese Patent Application Laid-open No. 2003-56551, a method for improving rotational accuracy by devising a bearing part is proposed, but the method cannot cope with the run out of a gravure plate cylinder.

The present invention has been created in view of these circumstances, and it is an object of the present invention to provide a state of stable coating where any nonuniformity appears even for the coating of a thin layer in the production of an optical film or the like by a gravure coating apparatus.

In order to achieve the object, the present invention provides a gravure coating apparatus, comprising: a gravure roller which coats a coating liquid on the lower surface of a running belt-like flexible substrate, wherein the gravure roller with no load has a radial run out of 15 μm or less in all places of a pattern part in which cells are formed on the surface of the gravure roller.

According to the present invention, since the gravure roller with no load has a radial run out of 15 μm or less in all places of a pattern part in which cells are formed (the gravure plate cylinder) on the surface of the gravure roller, liquid accumulations (beads) are hardly affected by the radial run out of the roller surface, thereby making it possible to prevent coating nonuniformity.

Further, the present invention provides a gravure coating apparatus, comprising: a gravure roller which coats a coating liquid on the lower surface of a running belt-like flexible substrate, wherein misalignment between the shaft center of a driving shaft connected to the end of the gravure roller and the shaft center of the gravure roller is 50 μm or less.

According to the present invention, since misalignment between the shaft center of a driving shaft connected to the end of the gravure roller and the shaft center of the gravure roller is small, liquid accumulations (beads) are hardly affected by the radial run out of the roller surface, thereby making it possible to prevent coating nonuniformity.

Furthermore, the present invention provides a gravure coating apparatus, comprising: a gravure roller which coats a coating liquid on the lower surface of a running belt-like flexible substrate, wherein the gravure roller during coating has a radial run out of 30 μm or less in all places of a pattern part in which cells are formed on the surface of the gravure roller.

According to the present invention, since the gravure roller during coating has a radial run out of 30 μm or less in all places of a pattern part in which cells are formed (the gravure plate cylinder) on the surface of the gravure roller, liquid accumulations (beads) are hardly affected by the radial run out of the roller surface, thereby making it possible to prevent coating nonuniformity.

In the present invention, the coating liquid which is coated preferably has a thickness of from 1 to 10 μm during coating. In addition, in the present invention, the coating liquid which is coated preferably has a thickness deviation of ±1.25% or less. The coating in which the above-described film thickness can be achieved is desirable for optical films.

The optical films include films with various functions such as optical compensation films, antireflection films and antiglare films.

As described above, according to the present invention, liquid accumulations (beads) are hardly affected by the radial run out of the roller surface, thereby making it possible to prevent coating nonuniformity.

### BRIEF DESCRIPTION OF THE DRAWINGS

FIG. 1 is a schematic drawing illustrating the production line of optical compensation films to which the gravure coating apparatus according to the present invention is applied;

FIG. 2 is a sectional view illustrating the entire configuration of a gravure coating apparatus;

FIG. 3 is a schematic drawing illustrating a state in which a state of coating is degraded in a gravure coating apparatus;

FIG. 4 is a schematic drawing illustrating another state in which a state of coating is degraded in a gravure coating apparatus;

FIG. 5 is a schematic drawing illustrating still another state in which a state of coating is degraded in a gravure coating apparatus;

FIG. 6 is a schematic drawing illustrating a method for eliminating defective conditions in conventional examples;

FIG. 7 is a schematic drawing illustrating another method for eliminating defective conditions in conventional examples; and

FIG. 8 is a table illustrating the results of examples.

### DETAILED DESCRIPTION OF THE PREFERRED EMBODIMENTS

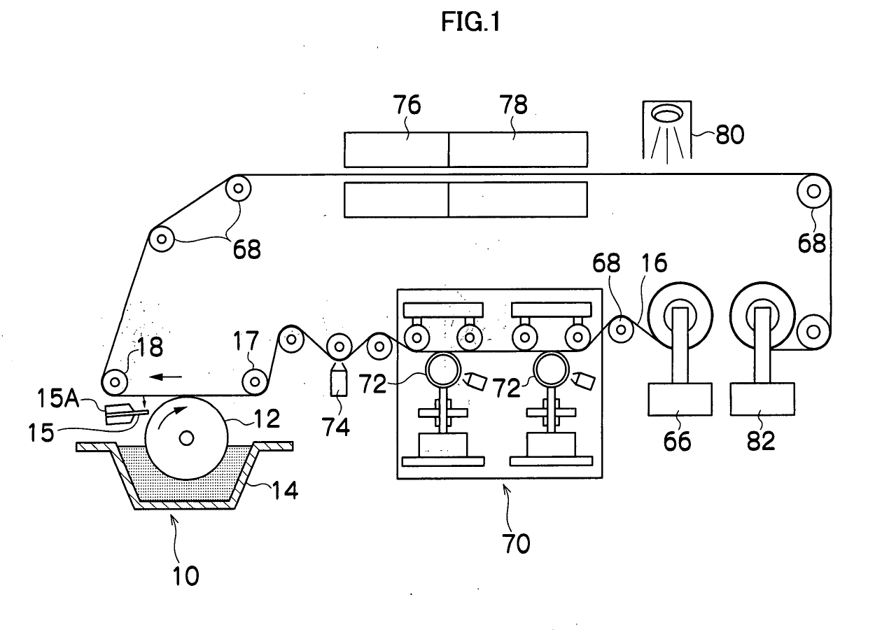

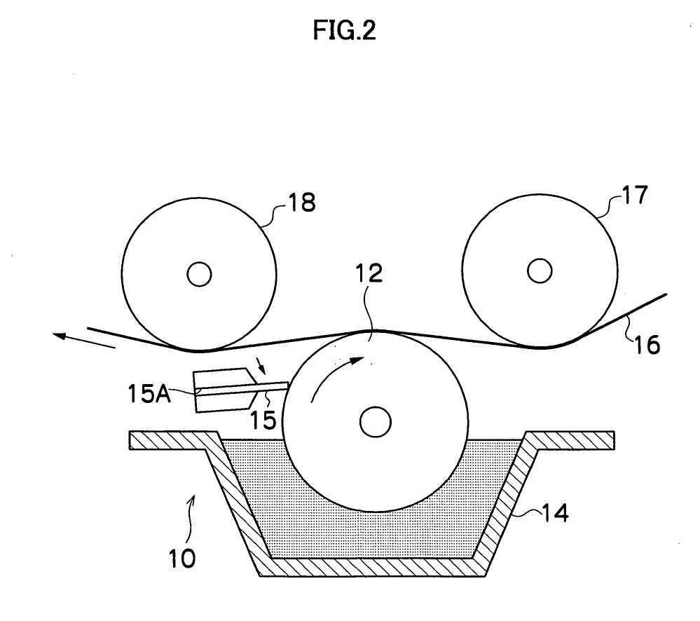

A preferred embodiment (a first embodiment) of the gravure coating apparatus and optical films according to the present invention will now be described in detail below in accordance with the attached drawings. FIG. 1 is a schematic drawing illustrating the production line of optical compensation films to which the gravure coating apparatus according to the present invention is applied. FIG. 2 is a sectional view illustrating an example of the gravure coating apparatus 10 which is a coating device in the above production line.

As shown in FIG. 1, the production line of optical compensation films comprises a feeder 66 which is adapted to feed a web 16 which is a transparent substrate with a polymer layer for forming an alignment layer formed thereon in advance. The web 16 is guided by a guide roller 68 so as to be fed to a rubbing treatment apparatus 70. Rubbing rollers 72 are provided to subject the polymer layer to rubbing treatment. A dust collector 74 is provided downstream of the rubbing rollers 72 so that dust adhered to the surface of the web 16 can be removed.

The gravure coating apparatus 10 is provided downstream of the dust collector 74 so that a coating liquid containing a discotic nematic liquid crystal can be coated on the web 16. A drying zone 76 and a heating zone 78 are sequentially provided downstream of the gravure coating apparatus 10 so that a liquid crystal layer can be formed on the web 16. Further, an ultraviolet lamp 80 is provided downstream of the drying zone 76 and the heating zone 78 so that the ultraviolet irradiation allows the liquid crystal to be crosslinked, thereby forming a desired polymer. Furthermore, a winder 82 is provided downstream of the ultraviolet lamp 80 so as to wind the web 16 with a polymer formed thereon.

As shown in FIG. 2, the gravure coating apparatus 10 is an apparatus for applying a coating liquid to the web 16 which runs guided by an upstream guide roller 17 and a downstream guide roller 18 with the gravure roller 12 which is rotatably driven. The upstream guide roller 17 and the downstream guide roller 18 are arranged such that the web 16 runs pressed to the gravure roller 12 with a predetermined pressure.

The gravure roller 12, the upstream guide roller 17 and the downstream guide roller 18 have about the same length as the width of the web 16.

The gravure roller 12 is rotatably driven as shown by an arrow in FIG. 2. The direction of rotation is reverse to the running direction of the web 16. On the other hand, coating with the gravure roller 12 that is rotatably driven in the forward direction opposite to that in FIG. 2 can be adopted by devising coating conditions (for example, the position of a doctor blade).

The gravure roller 12 is typically driven by direct drive (shaft direct coupling) with an inverter motor, but may be driven by a method in which various motor are each combined with a speed reducer (gear head), or a method in which a winding-type transmission device such as a timing belt is used for various motors.

The shape of cells on the surface of the gravure roller 12 may be of any known types such as a pyramid-type, a grid-type and an oblique line-type. That is, any suitable type of cells may be selected depending on coating speed, viscosity of a coating liquid, thickness of a coating film or the like.

A liquid receiving pan 14 is provided under the gravure roller 12, and it is filled with a coating liquid. About half of the lower part of the gravure roller 12 is immersed in the coating liquid. The coating liquid is supplied to the cells on the surface of the gravure roller 12 by the configuration of the gravure coating apparatus.

A doctor blade 15 is provided such that the leading end of the same is in contact with the gravure roller 12 at about a ten o'clock position thereof in order to scrape off the excess of the coating liquid before coating. The doctor blade 15 is urged by an urging device, not shown, in the arrow direction in FIG. 2 about a swinging center 15A at the base end thereof.

A hollow iron pipe with chromium plating on the surface thereof, a hollow aluminum pipe with hard plating on the surface thereof, a hollow aluminum pipe itself or the like can be adopted as the upstream guide roller 17 and the downstream guide roller 18.

The upstream guide roller 17 and the downstream guide roller 18 are substrated in a parallel state with the gravure roller 12. In addition, the upstream guide roller 17 and the downstream guide roller 18 are preferably constructed such that both ends thereof are swingably substrated with bearing members (ball bearings or the like) and they are not provided with driving mechanisms.

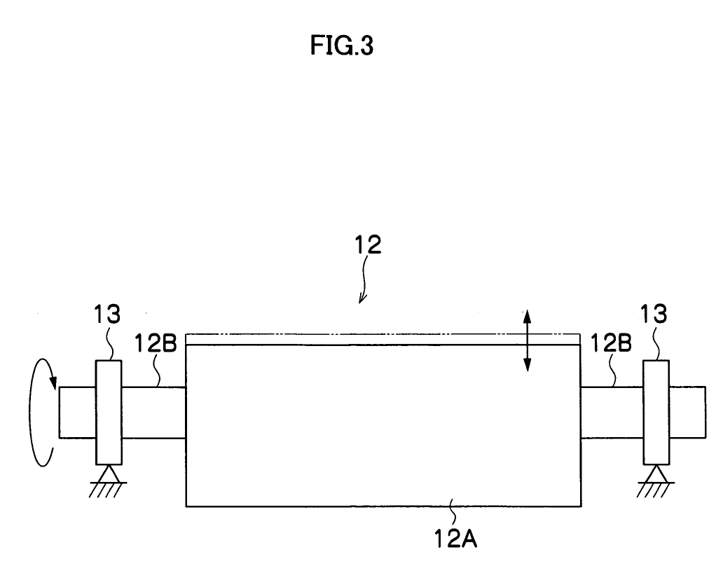

A specific device for achieving the configuration of the gravure coating apparatus according to the present invention will now be described. First, each state in which a state of coating is degraded in the gravure coating apparatus 10 is shown in FIGS. 3 to 5.

FIG. 3 illustrates a state in which the gravure roller 12 (with shafts 12B) is substrated by bearing members 13 and rotated in the arrow direction. In this state, the radial run out of the gravure plate cylinder 12A is large as shown by a solid line and an imaginary line in FIG. 3.

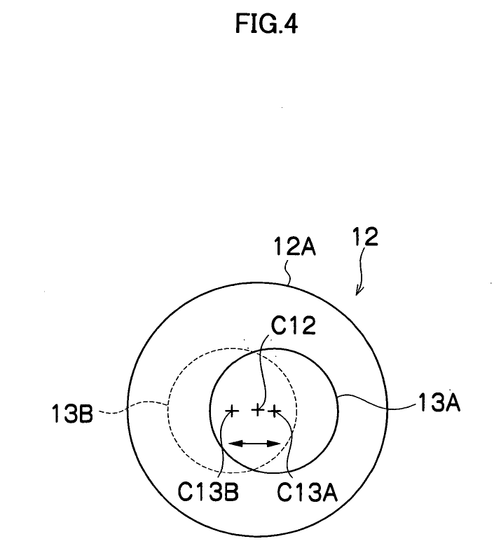

FIG. 4 is a side view of the gravure roller 12, which illustrates a state in which there is misalignment between the shaft center of each of the bearing members 13A, 13B fitted to each end of the gravure roller 12 and that of the gravure plate cylinder 12A. That is, each of the shaft centers C13A, C13B of the bearing members 13A, 13B is considerably shifted relative to the shaft center C12 of the gravure roller 12. Shafts 12B are not shown in FIG. 4.

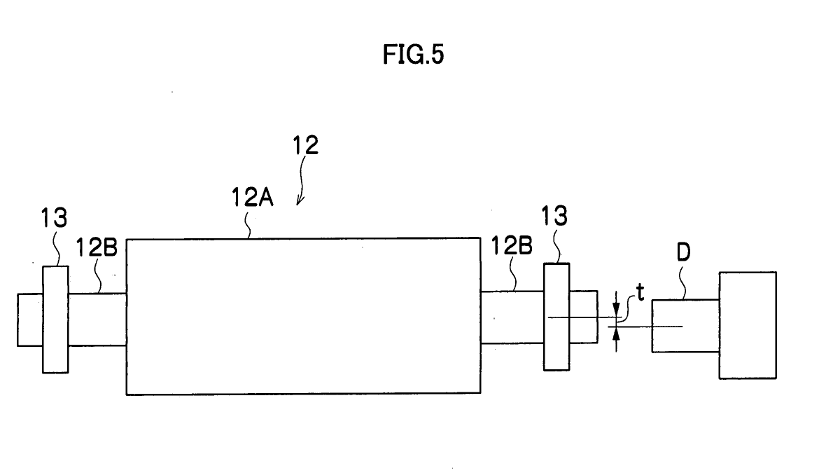

FIG. 5 illustrates a state in which the gravure roller 12 (with shafts 12B) is substrated by the bearing members 13 and further coupled to a drive shaft D at one end of the shaft 12B. In this state, the misalignment t between the shaft center of the gravure roller 12 and that of the drive shaft D has a certain value. Even when there appears a misalignment of t between the shaft center of the gravure roller 12 and that of the drive shaft D, transmission of a driving force is possible by use of known devices such as Oldham coupling, universal joint and flexible coupling. However, large misalignment t would often produce run out in the gravure plate cylinder 12A or generate vibration, thereby adversely affecting the coating.

In particular, a long gravure roller (for example, having a length of a gravure plate cylinder corresponding to the width of the web 16 of about 1.5 m) in a conventional gravure coating apparatus has a radial run out around the center of the gravure plate cylinder of about 30 μm or more. This state adversely affects the coating film in controlling the thickness thereof uniformly in the width direction of the web 16. That is, the radial run out of the gravure plate cylinder changes the size or the shape of beads (liquid accumulations in the parts where the gravure plate cylinder is in contact with the web), or, when a doctor blade is provided in combination, the run out varies the state of contact of the leading end of the blade to the gravure plate cylinder, thereby making it insufficient to control the film thickness to be applied.

Specifically, the coating film applied by a gravure coating apparatus in the above-described state may have a nonuniformity of about 5% in one rotation of the gravure roller. This nonuniformity poses a serious quality problem for optical films.

As described above, following devices can be adopted in order to eliminate defective conditions shown in FIGS. 3 to 5.
1) To improve the accuracy of finishing of the gravure roller 12 itself.
2) To improve the concentricity (the extent of misalignment between shaft centers) between the bearing members fitted to both ends of the gravure roller and all places of the gravure plate cylinder 12A.
3) To minimize the misalignment between the shaft center of the drive shaft D and that of the gravure roller 12.

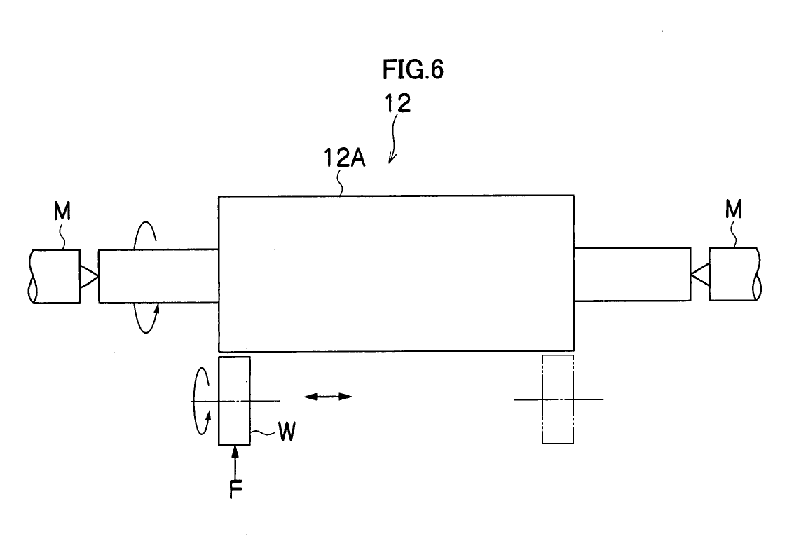

Specific methods for achieving the above-described devices will be described below. FIG. 6 is a schematic drawing on a specific method for the 1). In FIG. 6, the gravure roller 12 with cells formed on the surface thereof is substrated and rotatably driven on a work table of an external cylindrical grinding machine. Specifically, the gravure roller 12 for finishing is substrated by tailstocks M, M at the both ends thereof. In this state, a rotatably driven grinding wheel W reciprocates in a transverse direction while being pressed against the surface of the gravure plate cylinder 12A by a pressing force F.

It is possible to improve the accuracy of finishing of the gravure roller 12 itself by finishing it with a smaller pressing force F for a longer time than economy-oriented finishing conditions for typical grinding.

Moreover, the configuration is preferably adopted in which a backup roller is provided at the opposite side (upper surface in FIG. 6) of the surface to be finished (lower surface in FIG. 6) of the gravure roller 12 to prevent deformation of the gravure roller 12 during finishing.

The method can be applied to any case where the cells of the gravure plate cylinder 12A are formed by engraving by pressing a mother roll having fine projections and depressions on the surface thereof; or where the cells of the gravure plate cylinder 12A are formed by sand blasting; or where the cells of the gravure plate cylinder 12A are formed by laser beam machining; or where the cells of the gravure plate cylinder 12A are formed by photo etching; or the like.

In particular, in the case where the cells of the gravure plate cylinder 12A are formed by engraving by pressing a mother roll having fine projections and depressions on the surface thereof, a method of finishing with a smaller pressing force F for a longer time, or a method of finishing in which a backup roller is provided to prevent deformation of the gravure roller 12 during finishing can be preferably adopted.

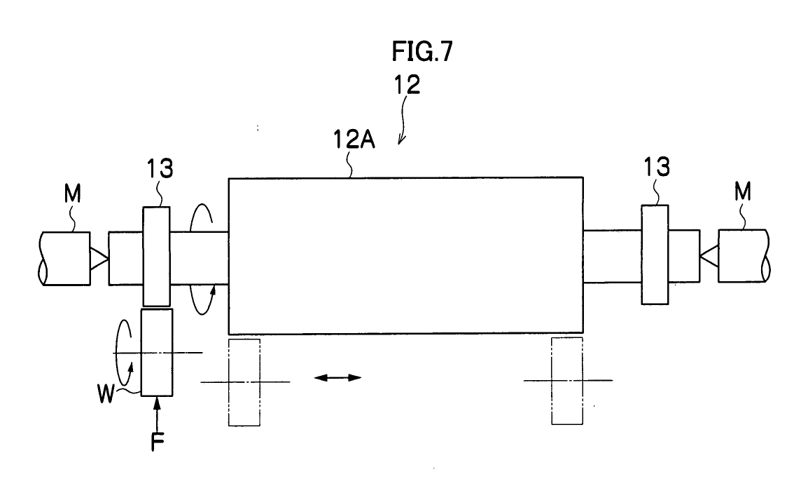

FIG. 7 is a schematic drawing on a specific method for the 2). In FIG. 7, the gravure roller 12 is substrated and rotatably driven on a work table of an external cylindrical grinding machine with bearing members 13 fitted near the both ends thereof. Specifically, the gravure roller 12 is substrated by tailstocks M, M at the both ends thereof. In this state, a rotatably driven grinding wheel W reciprocates in a transverse direction while being pressed against the surface of the gravure plate cylinder 12A by a pressing force F, as well as it grinds the periphery of the bearing members 13.

This can improve the concentricity (the extent of misalignment between shaft centers) between the bearing members 13 and the gravure plate cylinder 12A. In this grinding, a method of finishing with a smaller pressing force F for a longer time, or a method of finishing in which a backup roller is provided to prevent deformation of the gravure roller 12 during finishing, as described above, can also be adopted in combination.

In addition to the devices of 1) and 2), a method is also effective in which a plurality of gravure rollers 12 are manufactured and finished; then the accuracy of finishing of these gravure rollers 12 is measured; and those having a good accuracy of finishing are selected for use.

Furthermore, as an ultimate method, a method in which the gravure roller 12 is finished on the machine (on the gravure coating apparatus 10) can be adopted. In this case, combination of this method with the devices of 1) and 2) will achieve particularly good results.

In the present embodiment, the gravure coating apparatus 10 is preferably installed in a clean atmosphere such as a clean room. The clean room preferably has a cleanliness of Class 1000 or less, more preferably Class 100 or less, most preferably Class 10 or less.

Since the above-described gravure coating apparatus 10 is particularly effective in thin layer coating, it can be suitably applied, for example, to the production line of optical compensation films in which the thin layer coating with a wet coating volume of 10 ml/m² or less is performed.

Next, optical films that are produced by using the gravure coating apparatus according to the present invention will be described.

A polymer film having a light transmittance of 80% or higher is preferably used as a web 16 used in the present invention. The polymer film is preferably a film resistant to occurrence of birefringence. Examples of the polymer include cellulose polymers, norbornene polymers (for example, ARTON (from JSR Corporation), ZEONOR and ZEONEX (both from ZEON Corporation)) and polymethylmethacrylate. Cellulose polymers are preferred; cellulose esters are more preferred; and lower fatty acid esters of cellulose are most preferred.

The lower fatty acids mean fatty acids having carbon atoms of 6 or less. The number of carbon atoms is preferably 2 (cellulose acetates), 3 (cellulose propionates) or 4 (cellulose butyrates). As cellulose esters, cellulose acetates are preferred, and examples thereof include diacetyl cellulose, triacetyl cellulose, and the like. Mixed fatty acid esters such as cellulose acetate propionate and cellulose acetate butyrate may be used.

Generally, the total degree of substitution is not evenly distributed to hydroxy groups at 2-, 3- and 6-positions in cellulose acetates, that is, ⅓ of the total to each group, but the degree of substitution for the 6-position hydroxy group tends to be smaller. In the present invention, the degree of substitution for the 6-position hydroxy group of cellulose acetates is preferably higher than that for the 2- and 3-positions.

The 6-position hydroxy group is preferably substituted with an acyl group in an amount of from 30% to 40%, more preferably from 31%, and most preferably from 32%, based on the total degree of substitution. Furthermore, the degree of substitution of the 6-position acyl group of cellulose acetates is preferably 0.88 or more.

The 6-position hydroxy group may be substituted with an acetyl group, as well as an acyl group having carbon atoms of 3 or more such as a propionyl group, a butyroyl group, a valeroyl group, a benzoyl group or an acryloyl group. The degree of substitution of each position can be determined by NMR.

Cellulose acetates which can be used as the cellulose acetates in the present invention include those obtained by synthetic methods disclosed in Japanese Patent Application Laid-open No. 11-5851 as Synthesis Example 1 described in paragraph numbers 0043 and 0044, Synthesis Example 2 described in paragraph numbers 0048 and 0049, and Synthesis Example 3 described in paragraph numbers 0051 and 0052.

In order to adjust retardation, an aromatic compound having at least two aromatic rings is used as a retardation enhancing agent.

When a cellulose acetate film is used as the polymer film, the aromatic compound is used in the range of 0.01 to 20 mass parts based on 100 mass parts of cellulose acetate. The aromatic compound is preferably used in the range of 0.05 to 15 mass parts, more preferably in the range of 0.1 to 10 mass parts, based on 100 parts of cellulose acetate. Two or more types of the aromatic compounds may be used in combination. The aromatic rings of the aromatic compounds include aromatic hydrocarbon rings as well as aromatic heterocyclic rings.

The aromatic hydrocarbon rings most preferably include the 6-membered ring (that is, the benzene ring). The aromatic heterocyclic rings generally include unsaturated heterocyclic rings. The aromatic heterocyclic rings preferably include 5-membered rings, 6-membered rings or 7-membered rings, more preferably 5-membered rings or 6-membered rings. The aromatic heterocyclic rings generally have maximum numbers of double bonds. Hetero atoms preferably include nitrogen atoms, oxygen atoms and sulfur atoms, most preferably nitrogen atoms.

Examples of the aromatic heterocyclic rings include the furan ring, thiophene ring, pyrrole ring, oxazole ring, isoxazole ring, thiazole ring, isothiazole ring, imidazole ring, pyrazole ring, furazan ring, triazole ring, pyrane ring, pyridine ring, pyridazine ring, pyrimidine ring, pyrazine ring and 1,3,5-triazine ring. The aromatic rings preferably include the benzene ring, furan ring, thiophene ring, pyrrole ring, oxazole ring, thiazole ring, imidazole ring, triazole ring, pyridine ring, pyrimidine ring, pyrazine ring and 1,3,5-triazine ring, more preferably the benzene ring and 1,3,5-triazine ring. The aromatic compounds most preferably have at least one 1,3,5-triazine ring.

The number of aromatic rings in the aromatic compounds is preferably 2 to 20, more preferably 2 to 12, more preferably 2 to 8, most preferably 2 to 6. The linkage relationship of the two aromatic rings is classified into (a) the case where a condensed ring is formed, (b) the case where they are directly bonded by a single bond and (c) the case where they are bonded through a coupling group (the spiro linkage cannot be formed since they are aromatic rings). The linkage relationship may be any of (a) to (c).

Examples of (a) the condensed rings (composed of two or more aromatic rings) include the indene ring, naphthalene ring, azulene ring, fluorene ring, phenanthrene ring, anthracene ring, acenaphtylene ring, naphthacene ring, pyrene ring, indole ring, isoindole ring, benzofuran ring, benzothiophene ring, indolizine ring, benzoxazole ring, benzothiazole ring, benzoimidazole ring, benzotriazole ring, purine ring, indazole ring, chromene ring, quinoline ring, isoquinoline ring, quinolizine ring, quinazoline ring, cinnoline ring, quinoxaline ring, phthalazine ring, pteridine ring, carbazole ring, acridine ring, phenanthridine ring, xanthene ring, phenazine ring, phenothiazine ring, phenoxathiine ring, phenoxazine ring and thianthrene ring. The naphthacene ring, azulene ring, indole ring, benzoxazole ring, benzothiazole ring, benzoimidazole ring, benzotriazole ring and quinoline ring are preferred.

The single bond (b) is preferably a bond between carbon atoms of the two aromatic rings. The two aromatic rings may be bonded by two or more single bonds to form an aliphatic ring or a non-aromatic heterocyclic ring between the two aromatic rings.

The coupling group (c) also preferably bonded to carbon atoms in the two aromatic rings. The coupling group is preferably an alkylene group, alkenylene group, alkynylene group, —CO—, —O—, —NH— or —S—, or a combination thereof. Examples of the coupling group composed of a combination are shown below. In the examples of the coupling group, the relationship of right and left may be reversed.
c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: -alkylene-CO—O-alkylene-O—CO-alkylene-O—
c13: —O—CO-alkylene-CO—O—
c14: —NH—CO-alkenylene-
c15: —O—CO-alkenylene-

The aromatic rings and coupling groups may have substituents. Examples of substituents include halogen atoms (F, Cl, Br, I), hydroxyl, carboxyl, cyano, amino, nitro, sulfo, carbamoyl, sulfamoyl, ureide, alkyl groups, alkenyl groups, alkynyl groups, aliphatic acyl groups, aliphatic acyloxy groups, alkoxy groups, alkoxycarbonyl groups, alkoxycarbonylamino groups, alkylthio groups, alkylsulfonyl groups, aliphatic amide groups, aliphatic sulfonamide groups, substituted aliphatic amino groups, substituted aliphatic carbamoyl groups, substituted aliphatic sulfamoyl groups, substituted aliphatic ureide groups and non-aromatic heterocyclic groups.

The number of carbon atoms of the alkyl group is preferably one to eight. A chain alkyl group is more preferable than a cyclic alkyl group, and a straight-chain alkyl group is most preferable. Moreover, the alkyl group may have a substituent (for example, a hydroxy, carboxy, alkoxy group, and an alkyl-substituted amino group). Examples of the alkyl groups (including substituted alkyl groups) include methyl, ethyl, n-butyl, n-hexyl, 2-hydroxyethyl, 4-carboxybutyl, 2-methoxyethyl and 2-diethylaminoethyl. The number of carbon atoms of the alkenyl group is preferably two to eight. A chain alkenyl group is more preferable than a cyclic alkenyl group, and a straight-chain alkenyl group is most preferable. Moreover, the alkenyl group may have a substituent.

Examples of the alkenyl groups include vinyl, allyl and 1-hexenyl. The number of carbon atoms of the alkynyl group is preferably two to eight. A chain alkynyl group is more preferable than a cyclic alkynyl group, and a straight-chain alkynyl group is most preferable. Moreover, the alkynyl group may have a substituent. Examples of the alkynyl groups include ethynyl, 1-butynyl and 1-hexynyl.

The number of carbon atoms of the aliphatic acyl group is preferably one to ten. Examples of the aliphatic acyl groups include acetyl, propanoyl and butanoyl. The number of carbon atoms of the aliphatic acyloxy group is preferably one to ten. Examples of the aliphatic acyloxy groups include acetoxy. The number of carbon atoms of the alkoxy group is preferably one to eight. Moreover, the alkoxy group may have a substituent (for example, an alkoxy group).

Examples of the alkoxy group (including a substituted alkoxy group) include methoxy, ethoxy, butoxy and methoxyethoxy. The number of carbon atoms of the alkoxycarbonyl group is preferably two to eight. Examples of the alkoxycarbonyl groups include methoxycarbonyl and ethoxycarbonyl. The number of carbon atoms of the alkoxycarbonylamino group is preferably two to ten. Examples of the alkoxycarbonylamino groups include methoxycarbonylamino and ethoxycarbonylamino.

The number of carbon atoms of the alkylthio group is preferably one to twelve. Examples of the alkylthio groups include methylthio, ethylthio and octylthio.

The number of carbon atoms of the alkylsulfonyl group is preferably one to eight. Examples of the alkylsulfonyl groups include methanesulfonyl and ethanesulfonyl.

The number of carbon atoms of the aliphatic amide group is preferably one to ten. Examples of the aliphatic amide groups include acetamide. The number of carbon atoms of the aliphatic sulfonamide group is preferably one to eight. Examples of the aliphatic sulfonamide groups include methanesulfonamide, butanesulfonamide and n-octanesulfonamide. The number of carbon atoms of the substituted aliphatic amino group is preferably one to ten. Examples of the substituted aliphatic amino groups include dimethylamino, diethylamino and 2-carboxyethylamino.

The number of carbon atoms of the substituted aliphatic carbamoyl group is preferably two to ten. Examples of the substituted aliphatic carbamoyl groups include methylcarbamoyl and diethylcarbamoyl. The number of carbon atoms of the substituted aliphatic sulfamoyl group is preferably one to eight. Examples of the substituted aliphatic sulfamoyl groups include methylsulfamoyl and diethylsulfamoyl. The number of carbon atoms of the substituted aliphatic ureide group is preferably two to ten. Examples of the substituted aliphatic ureide groups include methylureide. Examples of the non-aromatic heterocyclic groups include piperidino and morpholino. The retardation enhancing agent preferably has a molecular weight of 300 to 800.

Examples of the retardation enhancing agents are described in Japanese Patent Application Laid-opens No. 2000-111914 and No. 2000-275434, and PCT/JP00/02619.

The case where a cellulose acetate film is used as a polymer film will be specifically described below. The cellulose acetate film is preferably produced by a solvent-cast method. In the solvent-cast method, the film is produced using a solution (dope) prepared by dissolving cellulose acetate in an organic solvent.

The organic solvent preferably includes a solvent selected from the group consisting of an ether having a number of carbon atoms of 3 to 12, a ketone having a number of carbon atoms of 3 to 12, an ester having a number of carbon atoms of 3 to 12 and a halogenated hydrocarbon having a number of carbon atoms of 1 to 6.

Ethers, ketones and esters may have a cyclic structure. A compound having any two or more functional groups selected from the functional groups of ethers, ketones and esters (that is, —O—, —CO— and —COO—) may be used as an organic solvent. The organic solvent may have another functional group such as an alcoholic hydroxy group. In the case of an organic solvent having two or more functional groups, the number of carbon atoms may be within the definition of the compound having any of the functional groups.

Examples of ethers having a number of carbon atoms of 3 to 12 include diisopropyl ether, dimethoxy methane, dimethoxy ethane, 1,4-dioxane, 1,3-dioxolane, tetrahydrofuran, anisole and phenetole. Examples of ketones having a number of carbon atoms of 3 to 12 include acetone, methyl ethyl ketone, diethyl ketone, diisobutyl ketone, cyclohexanone and methylcyclohexanone. Examples of esters having a number of carbon atoms of 3 to 12 include ethyl formate, propyl formate, pentyl formate, methyl acetate, ethyl acetate and pentyl acetate.

Examples of organic solvents having two or more functional groups include 2-ethoxyethyl acetate, 2-methoxy ethanol and 2-butoxy ethanol. The number of carbon atoms of halogenated hydrocarbons is preferably one or two, most preferably one. The halogen in the halogenated hydrocarbons is preferably chlorine. The proportion of the substitution of hydrogen for halogen in halogenated hydrocarbons is preferably 25 to 75 mol %, more preferably 30 to 70%, further preferably 35 to 65%, and most preferably 40 to 60%. Methylene chloride is a representative halogenated hydrocarbon.

Technically, halogenated hydrocarbons such as methylene chloride can be used without problems. However, in view of terrestrial environment and work environment, it is desirable that organic solvents be substantially free of halogenated hydrocarbons. “Substantially free of” means that the content of halogenated hydrocarbons in an organic solvent is less than 5 mass % (preferably less than 2 mass %). Further, it is desirable that halogenated hydrocarbons such as methylene chloride be not detected at all in cellulose acetate films produced. Two or more organic solvents may be mixed for use.

A cellulose acetate solution can be prepared by a general method. The general method means that treatment is performed at a temperature of 0° C. or higher (ordinary temperatures or elevated temperatures). Preparation of the solution can be performed by using a method and an apparatus for preparing a dope in a typical solvent-cast method. In the general method, halogenated hydrocarbons (particularly, methylene chloride) is preferably used as an organic solvent. The amount of cellulose acetate is adjusted so that the content thereof in the resulting solution is in the range of 10 to 40 mass %. More preferably, the content of cellulose acetate is in the range of 10 to 30 mass %.

Optional additives to be described below may be added in the organic solvent (main solvent). The solution can be prepared by stirring cellulose acetate and an organic solvent at an ordinary temperature (0 to 40° C.). A high-concentration solution may be prepared by stirring them under pressurizing and heating conditions. Specifically, cellulose acetate and an organic solvent are charged into a pressure vessel, hermetically sealed, and stirred under pressure while heated to a temperature in the range of from the boiling point at an ordinary pressure of the solvent to less than a temperature where the solvent boils. The heating temperature is generally 40° C. or higher, preferably from 60 to 200° C., more preferably from 80 to 110° C.

Each component may be charged into the vessel after rough mixing in advance. Alternatively, they may be sequentially charged into the vessel. The vessel needs to be constructed so that it can be stirred. An inert gas such as nitrogen gas may be charged to pressurize the vessel. Alternatively, increase of vapor pressure of a solvent due to heating may be utilized. Each component may also be added under pressure after the vessel is hermetically sealed.

For heating the components, it is desirable to heat them from the outside of the vessel. For example, a jacket-type heating apparatus can be used. Moreover, it is also possible to heat the entire vessel by providing a plate heater outside the vessel and providing piping to circulate the liquid therethrough. Preferably, a stirring blade is provided inside the vessel for agitation. The stirring blade preferably has a length reaching the vicinity of the vessel wall. A scraping blade is preferably provided at the end of the stirring blade in order to replace a liquid film on the vessel wall. The vessel may be provided with instruments such as a pressure gauge and a thermometer. Each component is dissolved in the solvent in the vessel. The prepared dope is cooled and then removed from the vessel, or is removed from the vessel and then cooled with a heat exchanger or the like.

The preparation of the cellulose acetate solution (dope) of the present invention is performed according to dissolution and cooling as described below. First, cellulose acetate is slowly added under stirring to an organic solvent at a temperature near room temperature (−10 to 40° C.). When a plurality of solvents are used, the order of the addition thereof is not particularly limited.

For example, cellulose acetate may be added to a main solvent before another solvent (for example, a gelling solvent such as alcohol) is added to the mixture, or conversely cellulose acetate may be wetted with the gelling solvent before the main solvent is added to the mixture, which is effective to prevent non-homogeneous dissolution. The amount of cellulose acetate is adjusted so that the content thereof in the mixture is in the range of 10 to 40 mass %. More preferably, the content of cellulose acetate is in the range of 10 to 30 mass %. Further, optional additives as described below may be added to the mixture.

Next, the mixture is cooled to a temperature in the range of from −100 to −10° C. (preferably from −80 to −10° C., more preferably from −50 to −20° C., most preferably from −50 to −30° C.). The cooling can be performed, for example, in a dry ice/methanol bath (−75° C.) or a cooled diethylene glycol solution (−30 to −20° C.). By cooling as describe above, the mixture of cellulose acetate and an organic solvent solidifies. Cooling speed is not limited. However, in the case of batch-type cooling, the viscosity of the cellulose acetate solution increases with the decrease of temperature thereof, thereby reducing the cooling efficiency thereof. Therefore, it is necessary to provide an efficient dissolution vessel in order to achieve a predetermined cooling temperature.

Alternatively, after the cellulose acetate solution of the present invention is swelled, a predetermined cooling temperature can be achieved by passing the solution through a cooler for a short period of time which is cooled to the predetermined cooling temperature. Higher cooling speed is more preferable. However, 10,000° C./sec is the theoretical upper limit; 1,000° C./sec is the technical upper limit; and 100° C./sec is the practical upper limit.

The cooling speed is defined as a value obtained by dividing the difference between the temperature at the start of cooling and the final temperature after cooling by the time from the start of cooling to the time when final temperature after cooling is reached. The mixture is warmed to a temperature in the range of from 0 to 200° C. (preferably from 0 to 150° C., more preferably from 0 to 120° C., most preferably from 0 to 50° C.) to form a solution in which cellulose acetate flows in an organic solvent. The temperature increase may be achieved by just leaving the mixture in room temperature, or by warming it in a warm bath.

A homogeneous solution can be obtained as described above. When the dissolution is insufficient, the operation of cooling and warming may be repeated. It is possible to determine whether the dissolution is sufficient or not only by visually observing the appearance of the solution.

In the dissolution and cooling, it is desirable to use a hermetically sealed vessel in order to prevent the contamination of moisture due to condensation at the time of cooling. It is possible to reduce the time of dissolution by pressurizing at the time of cooling and reducing pressure at the time of warming in the cooling and warming operation. A pressure vessel is desirably used for performing the pressurization and decompression.

A solution in which cellulose acetate (acetylation degree: 60.9%, viscosity average degree of polymerization: 299) is dissolved in methyl acetate in an amount of 20 mass % by the dissolution and cooling has a pseudo phase transition point between gel and sol near 33° C. according to differential scanning calorimetric measurement (DSC). Below that temperature, the solution is in the form of homogeneous gel.

The solution, therefore, must be kept at a temperature above the pseudo-phase transition temperature, preferably at a temperature higher than the pseudo-phase transition temperature by about 10° C. However, the pseudo-phase transition temperature depends upon various conditions such the acetylation degree, the viscosity average polymerization degree and the concentration of cellulose acetate as well as the organic solvent to be used.

The cellulose acetate film is produced from the prepared cellulose acetate solution (dope) according to the solvent cast method. The retardation enhancing agent is preferably added to the dope. The dope is cast on a drum or a band, and the solvent is evaporated to form a film. The solid content of the dope before casting is controlled in the range of 10 to 40%, preferably in the range of 18 to 35%. The surface of the drum or band is preferably mirror-polished in advance.

The casting and drying steps of the solvent cast method are described in U.S. Pat. Nos. 2,336,310, 2,367,603, 2,492,078, 2,492,977, 2,492,978, 2,607,704, 2,739,069, 2,739,070, British Patent Nos. 640,731, 736,892, Japanese Examined Application Publication Nos. 45-4554, 49-5614, Japanese Patent Application Laid-open Nos. 60-176834, 60-203430 and 62-115035.

The dope is preferably cast on the drum or band having a surface temperature of 10° C. or below. After cast on the drum or band, the dope is preferably blown with air for 2 seconds or more to dry. The formed film may also be peeled from the drum or band and blown with hot air whose temperature is successively changed from 100° C. to 160° C. in order to evaporate remaining solvent. The above procedure is described in Japanese Examined Application Publication No. 5-17844. The procedure can shorten the time taken to complete the steps of casting to peeling. For performing the procedure, the dope must gel at the surface temperature of the drum or band during casting.

In the present invention, the cellulose acetate solution obtained may be cast as a monolayer liquid on a smooth band as the web 16 or on a drum, or may be cast as a plurality of cellulose acetate liquids in two layers or more. When a plurality of cellulose acetate solutions are cast, films may be prepared by casting and laminating solutions containing cellulose acetate from a plurality of casting ports provided spaced apart in the running direction of the web 16. For example, methods described in Japanese Patent Application Laid-open Nos. 61-158414, 1-122419, 11-198285 and the like can be applied.

Further, films may be prepared by casting the cellulose acetate solutions from two casting ports, which can be performed according to the methods described, for example, in Japanese Examined Application Publication No. 60-27562, Japanese Patent Application Laid-open Nos. 61-94724, 61-947245, 61-104813, 61-158413 and 6-134933. Furthermore, a method of casting cellulose acetate films described in Japanese Patent Application Laid-open No. 56-162617 may also be used, in which the flow of a high-viscosity cellulose acetate solution is enclosed with a low-viscosity cellulose acetate solution so that the high- and low-viscosity cellulose acetate solutions are cast at the same time.

Alternatively, a method, for example, described in Japanese Examined Application Publication No. 44-20235 may be used for preparing films, in which two casting ports are used; a film formed on the web 16 using a first casting port is peeled off; and a second casting is performed on the side of the film that has been in contact with the surface of the web 16. The cellulose acetate solutions to be cast may be the same or different, and are not particularly limited. A cellulose acetate solution with a different function may be cast from each casting port so that each of a plurality of cellulose acetate layers has each function.

Moreover, other functional layers (for example, an adhesion layer, dye layer, antistatic layer, antihalation layer, UV-absorbing layer, polarization layer or the like) may also be cast at the same time as the casting of the cellulose acetate solution of the present invention. It has been necessary to cast a cellulose acetate solution having a high-concentration and high-viscosity to prepare a monolayer liquid. In this case, the cellulose acetate solution has been often unstable to produce solids, leading to problems of hard spots or poor smoothness. As a solution of the above problem, a plurality of cellulose acetate solutions may be cast from casting ports to allow high-viscosity solutions to be simultaneously cast on the web 16, thereby preparing a film of a quality surface with good flatness. This also allows a cellulose acetate solution having a high concentration to be used to achieve reduction of the load for drying, thereby increasing the production speed of films.

A plasticizer can be added to the cellulose acetate film to enhance mechanical strength thereof or to shorten the time for drying. A phosphate ester or carboxylate ester is used as the plasticizer. Examples of the phosphate ester include triphenyl phosphate (TPP) and tricresyl phosphate (TCP). Typical examples of the carboxylate ester include phthalate esters and citrate esters.

Examples of the phthalate esters include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrate esters include triethyl o-acetylcitrate (OACTE) and tributyl o-acetylcitrate (OACTB).

Examples of other carboxylate esters include butyl oleate, methylacetyl ricinolate, dibutyl sebacate and various trimellitic esters. The plasticizers of phosphate esters (DMP, DEP, DBP, DOP, DPP, DEHP) are preferably used. Particularly preferred are DEP and DPP. The content of the plasticizer is preferably in the range of 0.1 to 25 mass %, more preferably in the range of 1 to 20 mass %, most preferably in the range of 3 to 15 mass % based on the amount of cellulose acetate.

A deterioration inhibitor (e.g., oxidation inhibitor, peroxide decomposer, radical inhibitor, metal inactivating agent, oxygen scavenger, amine) may be incorporated in the cellulose acetate film. The deterioration inhibitor is described in Japanese Patent Application Laid-open Nos. 3-199201, 5-1907073, 5-194789, 5-271471 and 6-107854. The content of the deterioration inhibitor is preferably in the range of 0.01 to 1 mass %, more preferably in the range of 0.01 to 0.2 mass % based on the amount of the solution (dope) to be prepared. If the content is less than 0.01 mass %, the deterioration inhibitor gives little effect. If the content is more than 1 mass %, the inhibitor often bleeds out (oozes out) to the surface of the film. Examples of particularly preferred deterioration inhibitors are butylated hydroxytoluene (BHT) and tribenzylamine (TBA).

Next, stretching of the polymer film will be described. The prepared cellulose acetate film (polymer film) can be stretched to control the retardation. The stretching ratio is preferably in the range of 3 to 100%. The thickness of the polymer film is preferably in the range of 40 to 140 μm, more preferably in the range of 70 to 120 μm. Moreover, the control of stretching conditions can decrease the standard deviation of the angle of the slow axis of optical compensation sheets.

A method of stretching is not particularly limited. Examples of the method include stretching with a tenter. When the film prepared according to the solvent cast method is laterally stretched with a tenter, the standard deviation of the slow-axis angle of the film can be decreased by controlling the state of the film after stretching. Specifically, the polymer film is subjected to stretching treatment for controlling a retardation value with a tenter. Then, the polymer film immediately after the stretching is maintained as it is at a temperature close to the glass transition temperature of the film.

When the film is maintained at a temperature lower than the glass transition temperature thereof, the standard deviation may be higher. Alternatively, as another example, when the film is longitudinally stretched between rolls, the standard deviation of the slow axis may be decreased by increasing the distance between the rolls.

Next, surface treatment of the polymer film will be described. When the polymer film is used as a transparent protective film of a polarizing plate, the polymer film is preferably subjected to a surface treatment. Examples of the surface treatment include corona discharge treatment, glow discharge treatment, flame treatment, acid treatment, alkali treatment and ultraviolet irradiation treatment. Acid treatment or alkali treatment, that is, a saponification treatment to the polymer film, is particularly preferred.

Next, an alignment layer will be described. The alignment layer has the function to define the direction of alignment of discotic liquid crystal molecules in an optical anisotropy layer. The alignment layer can be provided by devices such as rubbing treatment of organic compounds (preferably, polymers), oblique deposition of inorganic compounds, formation of a layer with microgrooves, or build-up of organic compounds (for example, φ-tricosanic acid, dioctadecylmethylammonium chloride and methyl stearate) by the Langmuir-Blodgett technique (LB film). Moreover, an alignment layer is also known in which alignment function is generated by providing an electric or magnetic field or by photoirradiation.

The alignment layer is preferably formed by the rubbing process of polymers. Polyvinyl alcohols are the polymer that is preferably used. A modified polyvinyl alcohol to which a hydrophobic group is bonded is particularly preferred. Since a hydrophobic group has compatibility with discotic liquid crystal molecules in the optical anisotropy layer, introduction of a hydrophobic group into a polyvinyl alcohol allows the discotic liquid crystal molecules to be homogeneously aligned.

A hydrophobic group is bonded to the end of the main chain or the side chain of a polyvinyl alcohol. The hydrophobic group is preferably an aliphatic group (preferably an alkyl group or an alkenyl group) having carbon atoms of 6 or more, or an aromatic group. When the hydrophobic group is bonded to the end of the main chain of a polyvinyl alcohol, a coupling group is preferably introduced between the hydrophobic group and the end of the main chain. Examples of the coupling group include —S—, —C(CN)R₁—, —NR₂—, —CS— and combinations thereof. The R₁ and R₂ are each a hydrogen atom or an alkyl group having carbon atoms of 1 to 6 (preferably, an alkyl group having carbon atoms of 1 to 6).

When the hydrophobic group is bonded to the side chain of a polyvinyl alcohol, a part of the acetyl group (—CO—CH₃) of the vinyl acetate unit of the polyvinyl alcohol may be substituted for an acyl group (—CO—R₃) having carbon atoms of 7 or more. R₃ is an aliphatic group having carbon atoms of 6 or more or an aromatic group. Commercially available modified polyvinyl alcohols (for example, MP103, MP203 and R1130 from Kuraray Co., Ltd.) may be used. The degree of saponification of a (modified) polyvinyl alcohol used for the alignment layer is preferably 80% or more. The degree of polymerization of the (modified) polyvinyl alcohol is preferably 200 or more.

The rubbing process is performed by rubbing the surface of an alignment layer several times with paper or cloth in a certain direction. A cloth in which fibers with a uniform length and diameter are planted is preferably used. After the discotic liquid crystal molecules of the optical anisotropy layer is aligned using the alignment layer, the alignment of the discotic liquid crystal molecules can be maintained even after removing the alignment layer. That is, although the alignment layer is essential in the production of an elliptically polarizing plate for aligning the discotic liquid crystal molecules, it is not essential in the optical compensation sheet produced.

When the alignment layer is provided between the transparent web 16 and the optical anisotropy layer, an undercoating layer (adhesion layer) is preferably provided between the transparent web 16 and the alignment layer. Citrate esters may be optionally added to stabilize surface quality.

Next, an optical anisotropy layer will be described. The optical anisotropy layer is formed from the discotic liquid crystal molecules. The discotic liquid crystal molecules generally have the optically negative uniaxiality. In the optical compensation sheet of the present invention, the discotic liquid crystal molecules have an angle between the surfaces of a disk plate and the transparent web 16 that varies in the depth direction of the optical anisotropy layer (having hybrid alignment) as shown in FIG. 2. The optical axis of the discotic liquid crystal molecules exists in the direction of the normal to the disk plate.

The discotic liquid crystal molecules have birefringence in which the refractive index in the optical axis direction is larger than that in the disk-plate direction. The optical anisotropy layer is preferably formed by aligning the discotic liquid crystal layer using the alignment layer and fixing the discotic liquid crystal molecules in this alignment state. The discotic liquid crystal molecules are preferably fixed by polymerization reaction.

The optical anisotropy layer has no direction in which a retardation value equals to zero. In other words, the minimum value of the retardation of the optical anisotropy layer is higher than zero. Specifically, the optical anisotropy layer preferably has a retardation value (Re) as defined by formula (I) in the range of 10 to 100 nm and a retardation value (Rth) as defined by formula (II) in the range of 40 to 250 nm. In addition, the discotic liquid crystal molecules have an average angle of inclination in the range of 20 to 50°.
Re=(nx−ny)xd (I)
Rth={(n2+n3)/2−n1}×d

In formula (I), nx is the refractive index in the slow-axis direction within the optical anisotropy layer; ny is the refractive index in the fast-axis direction within the optical anisotropy layer; and d is the thickness of the optical anisotropy layer. In formula (II), n1 is the minimum of the refraction index main values when the optical anisotropy layer is approximated to by the optical indicatrix; n2 and n3 are other refraction index main values of the optical anisotropy layer; and d is the thickness of the optical anisotropy layer.

The discotic liquid crystal molecules are described in various literatures (C.Destrade et al., Mol. Crysr. Liq. Cryst., vol. 71, page 111 (1981); “Chemistry of Liquid Crystals”, edited by The Chemical Society of Japan, quarterly chemical review, No. 22, chapter 5, section 2 of chapter 10 (1994); B. Kohne et al., Angew. Chem. Soc. Chem. Comm., page 1794 (1985); J. Zhang et al., J. Am. Chem. Soc., vol. 116, page 2655 (1994)). Japanese Patent Application Laid-open No. 8-27284 describes the polymerization of the discotic liquid crystal molecules.

In order to fix the discotic liquid crystal molecules by polymerization, it is necessary to bond a polymerizable group as a substituent to a discoid core of the discotic liquid crystal molecules. However, if the polymerizable group is directly bonded to the discoid core, it is difficult to keep the state of alignment in the polymerization reaction. In order to prevent the situation, a coupling group is introduced between the discoid core and the polymerizable group. Therefore, the discotic liquid crystal molecules having a polymerizable group are preferably the compounds represented by formula (III).
D(—L-Q)n (III)

In formula (III), D is a discoid core; L is a bivalent coupling group; Q is a polymerizable group; and n is an integer of 4 to 12.

Examples of discoid cores (D) are shown below. In the following examples, LQ (or QL) means a combination of a bivalent coupling group (L) and a polymerizable group (Q).

In formula (III), the bivalent coupling group (L) is preferably a bivalent coupling group selected from the group consisting of an alkylene group, alkenylene group, arylene group, —CO—, —NH—, —O—, —S— and combinations thereof. The bivalent coupling group (L) is more preferably a bivalent coupling group formed by combining at least two bivalent groups selected from the group consisting of an alkylene group, arylene group, —CO—, —NH—, —O— and —S—. The bivalent coupling group (L) is most preferably a bivalent coupling group formed by combining at least two bivalent groups selected from the group consisting of an alkylene group, arylene group, —CO— and —O—. The number of carbon atoms of the alkylene group is preferably from 1 to 12. The number of carbon atoms of the alkenylene group is preferably from 2 to 12. The number of carbon atoms of the arylene group is preferably from 6 to 10.

Examples of the bivalent coupling group (L) are shown below. The left side is bonded to the discoid core (D), and the right side is bonded to the polymerizable group (Q). AL means an alkylene group or an alkenylene group, and AR means an arylene group. The alkylene group, alkenylene group and arylene group each may have a substituent (for example, an alkyl group).
L1: -AL-CO—O-AL-
L2: -AL-CO—O-AL-O—
L3: -AL-CO—O-AL-O-AL-
L4: -AL-CO—O-AL-O—CO—
L5: —CO-AR-O-AL-
L6: —CO-AR-O-AL-O—
L7: —CO-AR-O-AL-O—CO—
L8: —CO—NH-AL-
L9: —NH-AL-O—
L10: —NH-AL-O—CO—
L11: —O-AL-
L12: —O-AL-O—
L13: —O-AL-O—CO—
L14: —O-AL-O—CO—NH-AL-
L15: —O-AL-S-AL-
L16: —O—CO-AR-O-AL-CO—
L17: —O—CO-AR-O-AL-O—CO—
L18: —O—CO-AR-O-AL-O-AL-O—CO—
L19: —O—CO-AR-O-AL-O-AL-O-AL-O—CO—
L20: —S-AL-
L21: —S-AL-O—
L22: —S-AL-O—CO—
L23: —S-AL-S-AL-
L24: —S-AR-AL-

The polymerizable group (Q) in formula (III) is determined according to the type of the polymerization reaction.

The polymerizable group (Q) is preferably an unsaturated polymerizable group (Q1 to Q7) or an epoxy group (Q8), more preferably an unsaturated polymerizable group, most preferably an ethylenic unsaturated polymerizable group (Q1 to Q6). In formula (III), n is an integer of 4 to 12.

A specific number is determined according to the type of the discoid core (D). The combination of L and Q may be different for a plurality of combinations, but it is preferably the same.

The optical anisotropy layer can be formed by coating on the alignment layer a coating liquid containing discotic liquid crystal molecules and, if necessary, a polymerization initiator and optional components. The optical anisotropy layer preferably has a thickness in the range of 0.5 to 100 μm, more preferably in the range of 0.5 to 30 μm.

The aligned discotic liquid crystal molecules are fixed maintaining the state of the alignment. The fixation is preferably performed by polymerization reaction. The polymerization reaction includes thermal polymerization using a thermal polymerization initiator and photopolymerization using a photopolymerization initiator. The photopolymerization is preferred. Examples of the photopolymerization initiator include α-carbonyl compounds (described in U.S. Pat. Nos. 2,367,661 and 2,367,670), acyloin ethers (described in U.S. Pat. No. 2,448,828), α-hydrocarbon substituted aromatic acyloin compounds (described in U.S. Pat. No. 2,722,512), polynuclear quinone compounds (described in U.S. Pat. Nos. 3,046,127 and 2,951,758), combinations of a triarylimidazole dimer and p-aminophenyl ketone (described in U.S. Pat. No. 3,549,367), acridine and phenazine compounds (described in Japanese Patent Application Laid-open No. 60-105667 and U.S. Pat. No. 4,239,850) and oxadiazole compounds (described in U.S. Pat. No. 4,212,970).

The photopolymerization initiator is used preferably in an amount of 0.01 to 20 mass %, more preferably in an amount of 0.5 to 5 mass %, based on the solid content of the coating liquid. Ultraviolet light is preferably used as the photoirradiation for polymerizing the discotic liquid crystal molecules. The irradiation energy is preferably in the range of 20 to 5,000 mJ/cm², more preferably in the range of 100 to 800 mJ/cm². In addition, the photoirradiation may be performed under heating conditions for enhancing photopolymerization reaction. A protective layer may be provided on the optical anisotropy layer. Citrate esters may be added as necessary in order to stabilize surface quality.

Next, a method for producing optical films using the production line of optical compensation films shown in FIG. 1 will be described. First, a web 16, which has a polymer layer for forming an alignment layer formed thereon in advance and has a thickness in the range of 40 to 300 μm, is fed from a feeder 66. The web 16 is guided by a guide roller 68 and fed to a rubbing apparatus 70. The polymer layer is subjected to rubbing treatment with rubbing rollers 72. Next, dust adhered to the surface of the web 16 is removed by a dust collector 74, and then a coating liquid containing a discotic nematic liquid crystal is coated on the web 16 with a gravure coating apparatus 10.

At this time, since the radial run out is 15 μm or less in all places of the pattern part in which cells are formed (the gravure plate cylinder 12A) on the surface of the gravure roller 12, liquid accumulations (beads) are hardly affected by the radial run out of the roller surface, thereby making it possible to prevent coating nonuniformity. That is, the above-described state of coating can prevent the thickness of coating films from being heterogeneous, thereby improving the nonuniformity of the coating films as optical films.

Then, a crystal layer is formed through a drying zone 76 and a heating zone 78. Further, the liquid crystal layer is irradiated with an ultraviolet lamp 80 to allow the liquid crystal to be crosslinked, thereby forming a desired polymer. Then, the web 16 with the polymer formed thereon is winded with a winder 82.

An embodiment of a method for producing optical films according to the present invention has been described above. The present invention is not limited to the embodiment, but may take various embodiments.

For example, the gravure roller 12 is adopted in a gravure kiss coater in the present embodiment, as shown in FIG. 2. However, it can be suitably applied also in other coaters than that, for example, a direct gravure coater, an offset gravure coater, an electrostatic gravure coater or the like.

Furthermore, the gravure coating apparatus (gravure coater) 10 has applications not only for optical films, but also for various coatings.

### EXAMPLES

The gravure coating apparatus 10 shown in FIG. 2 was used to coat a coating liquid on the web 16 to produce an optical film (antiglare film).

A triacetyl cellulose (TAC) film having a thickness of 80 μm and a width of 1,000 mm was used as the web 16.

A coating liquid for an antiglare layer was prepared as described below. To 104 g of a mixed solvent consisting of methyl ethyl ketone/cyclohexanone=54/46% by weight, were dissolved 75 g of a mixture of dipentaerythritol pentaacrylate and dipentaerythritol hexaacrylate (DPHA from Nippon Kayaku Co., Ltd.) and 240 g of a hard-coating liquid containing a dispersion of zirconium oxide superfine particles with a particle size of about 30 nm (DeSolite Z-7401 from JSR Corporation).

To the resultant solution, was added and dissolved by stirring 10 g of a photopolymerization initiator (Irgacure 907 from Ciba Fine Chemicals K.K.). Then, to the resultant solution, was added 0.93 g of a fluorinated surfactant (Megafac F-176 PF from Dainippon Ink and Chemicals, Incorporated) composed of a 20 wt % solution of a fluorine-containing oligomer in methyl ethyl ketone (The resultant solution was coated and UV-cured to obtain a coating film, and the refractive index of the film was determined to be 1.65).

Further, to the resultant solution, was added and stirred 29 g of a dispersion obtained by stirring to disperse 20 g of crosslinked polystyrene particles (SX-200HS from Soken Chemical & Engineering Co., Ltd.) having a number average particle size of 2.0 μm and a refractive index of 1.61 into 160 g of a mixed solvent consisting of methyl ethyl ketone/cyclohexanone=54/46% by weight for one hour at 5,000 rpm with a high-speed Despa and filtering the resulting solution through polypropylene filters each having a pore size of 10 μm, 3 μm and 1 μm (PPE-10, PPE-03 and PPE-01, respectively, all from Fuji Photo Film, Co., Ltd.). The resulting solution was filtered through a polypropylene filter having a pore size of 30 μm to prepare the coating liquid for the antiglare layer.

The gravure roller 12 having a length of the gravure plate cylinder 12A of 1.5 m and an outer diameter of 100 mm was used. The cell pattern of the gravure plate cylinder 12A is of the oblique-line type.

The running speed of the web 16 was set at 10 m/min, and the rotation of the gravure roller 12 was set at 10 rpm, which was reverse to the running direction of the web 16. In this case, the peripheral velocity of the surface of the gravure roller 12 is 6 m/min.

Three types of gravure rollers 12 were used. Each type had a run out of the surface of the gravure plate cylinder 12A relative to the shaft center of 35 μm, 13 μm or 8 μm. In addition, two conditions were used, in which misalignment between the shaft center of the driving shaft D and the shaft center of the gravure roller 12 (refer to FIG. 5) for each condition was 50 μm or 100 μm. The maximum radial run out of the gravure roller 12 when it was rotatably driven was measured.

The measurements of the run out during the setting of the gravure roller 12 and during the rotational drive of the same were performed with a laser non-contact displacement measuring device.

As the evaluation of the coating film on the web 16, the thickness variations of films after drying were measured with an optical thickness meter using light-interference.

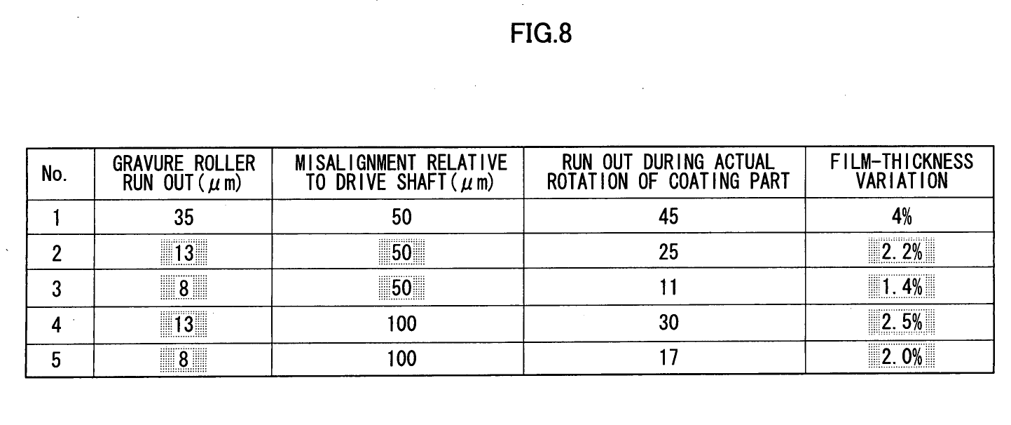

Apparatus conditions and evaluation results as described above are summarized in the table in FIG. 8.

In Example (No.) 1, the gravure roller 12 which has a run out of the surface of the gravure plate cylinder 12A relative to the shaft center of 35 μm was used, and the gravure roller 12 was set such that misalignment between the shaft center of the driving shaft D and the shaft center of the gravure roller 12 was 50 μm. In this case, the run out during the rotational drive of the gravure roller 12 was measured to be 45 μm. The thickness variation of the coating film was evaluated, and it was found that the film thickness variation generated in one rotation of the gravure roller 12 was 4%.

In Example (No.) 2, the gravure roller 12 which has a run out of the surface of the gravure plate cylinder 12A relative to the shaft center of 13 μm was used, and the gravure roller 12 was set such that misalignment between the shaft center of the driving shaft D and the shaft center of the gravure roller 12 was 50 μm. In this case, the run out during the rotational drive of the gravure roller 12 was measured to be 25 μm. The thickness variation of the coating film was evaluated, and it was found that the film thickness variation generated in one rotation of the gravure roller 12 was 2.2%.

In Example (No.) 3, the gravure roller 12 which has a run out of the surface of the gravure plate cylinder 12A relative to the shaft center of 8 μm was used, and the gravure roller 12 was set such that misalignment between the shaft center of the driving shaft D and the shaft center of the gravure roller 12 was 50 μm. In this case, the run out during the rotational drive of the gravure roller 12 was measured to be 11 μm. The thickness variation of the coating film was evaluated, and it was found that the film thickness variation generated in one rotation of the gravure roller 12 was 1.4%.

In Example (No.) 4, the gravure roller 12 which has a run out of the surface of the gravure plate cylinder 12A relative to the shaft center of 13 μm was used, and the gravure roller 12 was set such that misalignment between the shaft center of the driving shaft D and the shaft center of the gravure roller 12 was 100 μm. In this case, the run out during the rotational drive of the gravure roller 12 was measured to be 30 μm. The thickness variation of the coating film was evaluated, and it was found that the film thickness variation generated in one rotation of the gravure roller 12 was 2.5%.

In Example (No.) 5, the gravure roller 12 which has a run out of the surface of the gravure plate cylinder 12A relative to the shaft center of 8 μm was used, and the gravure roller 12 was set such that misalignment between the shaft center of the driving shaft D and the shaft center of the gravure roller 12 was 100 μm. In this case, the run out during the rotational drive of the gravure roller 12 was measured to be 17 μm. The thickness variation of the coating film was evaluated, and it was found that the film thickness variation generated in one rotation of the gravure roller 12 was 2.0%.

From the above results, it was confirmed that the film thickness in the width direction of the web 16 was able to be stabilized by reducing the run out of the surface of the gravure plate cylinder 12A relative to the shaft center to 15 μm or less.

1. A gravure coating apparatus, comprising:
a gravure roller which coats a coating liquid on the lower surface of a running belt-like flexible substrate,
wherein the gravure roller with no load has a radial run out of 15 μm or less in all places of a pattern part in which cells are formed on the surface of the gravure roller.

2. A gravure coating apparatus, comprising:
a gravure roller which coats a coating liquid on the lower surface of a running belt-like flexible substrate,
wherein misalignment between the shaft center of a driving shaft connected to the end of the gravure roller and the shaft center of the gravure roller is 50 μm or less.

3. A gravure coating apparatus, comprising:
a gravure roller which coats a coating liquid on the lower surface of a running belt-like flexible substrate,
wherein the gravure roller during coating has a radial run out of 30 μm or less in all places of a pattern part in which cells are formed on the surface of the gravure roller.

4. A gravure coating apparatus, comprising:
a gravure roller which coats a coating liquid on the lower surface of a running belt-like flexible substrate,
wherein the gravure roller with no load has a radial run out of 15 μm or less in all places of a pattern part in which cells are formed on the surface of the gravure roller, and misalignment between the shaft center of a driving shaft connected to the end of the gravure roller and the shaft center of the gravure roller is 50 μm or less.

5. The gravure coating apparatus according to claim 4, wherein the gravure roller during coating has a radial run out of 30 μm or less in all places of a pattern part in which cells are formed on the surface of the gravure roller.

6. An optical film with a coating layer formed thereon, wherein the gravure coating apparatus according to claim 1 is used to coat a coating liquid on the substrate.

7. An optical film with a coating layer formed thereon, wherein the gravure coating apparatus according to claim 2 is used to coat a coating liquid on the substrate.

8. An optical film with a coating layer formed thereon, wherein the gravure coating apparatus according to claim 3 is used to coat a coating liquid on the substrate.

9. An optical film with a coating layer formed thereon, wherein the gravure coating apparatus according to claim 4 is used to coat a coating liquid on the substrate.

10. An optical film with a coating layer formed thereon, wherein the gravure coating apparatus according to claim 5 is used to coat a coating liquid on the substrate.

11. The optical film according to claim 6, wherein the coating liquid which is coated has a thickness of from 1 to 10 μm during coating.

12. The optical film according to claim 7, wherein the coating liquid which is coated has a thickness of from 1 to 10 μm during coating.

13. The optical film according to claim 8, wherein the coating liquid which is coated has a thickness of from 1 to 10 μm during coating.

14. The optical film according to claim 9, wherein the coating liquid which is coated has a thickness of from 1 to 10 μm during coating.

15. The optical film according to claim 10, wherein the coating liquid which is coated has a thickness of from 1 to 10 μm during coating.

16. The optical film according to claim 11, wherein the coating liquid which is coated has a thickness deviation of ±1.25% or less.

17. The optical film according to claim 12, wherein the coating liquid which is coated has a thickness deviation of ±1.25% or less.

18. The optical film according to claim 13, wherein the coating liquid which is coated has a thickness deviation of +1.25% or less.

19. The optical film according to claim 14, wherein the coating liquid which is coated has a thickness deviation of ±1.25% or less.

20. The optical film according to claim 15, wherein the coating liquid which is coated has a thickness deviation of ±1.25% or less.
